(19) United States
(12) Patent Application Publication
(10) Pub. No.: US 2012/0318376 A1
(43) Pub. Date: Dec. 20, 2012

(54) CLEANING APPARATUS, RADIATION SOURCE MODULE AND FLUID TREATMENT SYSTEM

(75) Inventors: George Traubenberg, London (CA); Allan Archer, London (CA); Cristian Moglan, London (CA)

(73) Assignee: Trojan Technologies, London, ON (CA)

(21) Appl. No.: 13/509,448

(22) PCT Filed: Nov. 10, 2010
(86) PCT No.: PCT/CA10/01792

§ 371 Date: Sep. 6, 2012

Related U.S. Application Data
(60) Provisional application No. 61/272,858, filed on Nov. 12, 2009.

(51) Int. Cl. B08B 1/00

(52) U.S. Cl. 137/237

(57) ABSTRACT

There is described a cleaning apparatus for a surface (e.g., a radiation source assembly) in a fluid treatment system. A preferred embodiment of the cleaning apparatus comprises: a wiping element for contact with at least a portion of the surface; at least one cutting element connected to the wiping element for cutting elongate debris in contact with the surface; and a motive element for moving the carriage between a first position and a second position. This preferred embodiment of the present cleaning apparatus is particularly advantageous for removing elongate debris from one or more radiation source assemblies disposed in the fluid treatment system. The approach utilized in this preferred embodiment of the present cleaning apparatus is to include at least one cutting element which is moved along the exterior of the radiation source assembly. The cutting element is connected to a wiping element that is translated between a first position and a second position. As the wiping element is moved from the first position to the second position, it will tend to push the elongate debris toward a distal portion of the radiation source assembly. During this translation step, it is possible that some of the debris may be cut by the cutting element. As the wiping element approaches the distal portion of the radiation source assembly, it will tend to clamp down on the elongate debris and, as the force of movement is continually applied, the cutting element will cut the elongate debris. Once the elongate debris is cut, it will more readily fall away from the radiation source assembly and this action is facilitated by a flow of fluid past the radiation source assembly.

### CROSS-REFERENCE TO RELATED APPLICATION

The present application claims the benefit under 35 U.S.C. §119(e) of provisional patent application Ser. No. 61/272,858, filed Nov. 12, 2009, the contents of which are hereby incorporated by reference.

### FIELD OF THE INVENTION

In one of its aspects, the present invention relates to a fluid treatment system. In another of its aspects, the present invention relates to a cleaning apparatus. In yet another of its aspects, the present invention relates to a radiation source module containing the cleaning apparatus. In another of its aspects, the present invention relates to a method of removing fouling materials from an exterior surface of a radiation source assembly. Other aspects of the invention will become apparent to those of skill in the art upon reviewing the present specification.

### DESCRIPTION OF THE PRIOR ART

Fluid treatment systems are known generally in the art.

For example, U.S. Pat. Nos. 4,482,809, 4,872,980 and 5,006,244 [all in the name of Maarschalkerweerd and hereinafter referred to as the Maarschalkerweerd #1 patents] all describe gravity fed fluid treatment systems which employ ultraviolet (UV) radiation.

Such systems include an array of UV lamp frames which include several UV lamps each of which are mounted within sleeves which extend between and are supported by a pair of legs which are attached to a cross-piece. The so-supported sleeves (containing the UV lamps) are immersed into a fluid to be treated which is then irradiated as required. The amount of radiation to which the fluid is exposed is determined by the proximity of the fluid to the lamps, the output wattage of the lamps and the fluid's flow rate past the lamps. Typically, one or more UV sensors may be employed to monitor the UV output of the lamps and the fluid level is typically controlled, to some extent, downstream of the treatment device by means of level gates or the like.

Depending on the quality of the fluid which is being treated, the sleeves surrounding the UV lamps periodically become fouled with foreign materials, inhibiting their ability to transmit UV radiation to the fluid. For a given installation, the occurrence of such fouling may be determined from historical operating data or by measurements from the UV sensors. Once fouling has reached a certain point, the sleeves must be cleaned to remove the fouling materials and optimize system performance.

If the UV lamp modules are employed in an open, channel system (e.g., such as the one described and illustrated in Maarschalkerweerd #1 patents), one or more of the modules may be removed while the system continues to operate, and the removed frames may be immersed in a bath of suitable cleaning solution (e.g., a mild acid) which may be air-agitated to remove fouling materials. This practice was regarded by many in the field as inefficient, labourious and inconvenient.

In many cases, once installed, one of the largest maintenance costs associated with prior art fluid treatment systems is often the cost of cleaning the sleeves about the radiation sources.

U.S. Pat. Nos. 5,418,370, 5,539,210 and RE36,896 [all in the name of Maarschalkerweerd and hereinafter referred to as the Maarschalkerweerd #2 patents] all describe an improved cleaning system, particularly advantageous for use in gravity fed fluid treatment systems which employ UV radiation. Generally, the cleaning system comprises a cleaning carriage engaging a portion of the exterior of a radiation source assembly including a radiation source (e.g., a UV lamp). The cleaning carriage is movable between: (i) a retracted position wherein a first portion of radiation source assembly is exposed to a flow of fluid to be treated, and (ii) an extended position wherein the first portion of the radiation source assembly is completely or partially covered by the cleaning carriage. The cleaning carriage includes a chamber in contact with the first portion of the radiation source assembly. The chamber is supplied with a cleaning solution suitable for removing undesired materials from the first portion of the radiation source assembly.

The cleaning system described in the Maarschalkerweerd #2 patents represented a significant advance in the art, especially when implemented in the radiation source module and fluid treatment system illustrated in these patents.

In recent years, there has been interest in the so-called “transverse-to-flow” fluid treatment systems. In these systems, the radiation source is disposed in the fluid to be treated in a manner such that the longitudinal axis of the radiation source is in a transverse (e.g., orthogonal vertical orientation of the radiation sources) relationship with respect to the direction of fluid flow past the radiation source. See, for example, any one of:
International Publication Number WO 2004/000735 [Traubenberg et al.];
International Publication Number WO 2008/055344 [Ma et al.];
International Publication Number WO 2008/019490 [Traubenberg et al.];
U.S. Pat. No. 7,408,174 [From et al.]; and
U.S. provisional patent application Ser. No. 61/193,686 [Penhale et al.], filed Dec. 16, 2008.

When these fluid treatment systems have been implemented there is a problem of build-up of fouling materials on the exterior surface of the radiation sources. This is particularly a problem in the treatment of municipal waste water where such fouling materials have not been removed upstream of the UV disinfection system. The fouling material often takes the form of elongate debris (e.g., hair, condoms, string, algae and other string-like material) which catches on the exterior surface of the radiation sources and remains there. Failure to adequately remove such fouling material leads to a number of problems, including one or more of the following:
reduced radiation dose delivered to the flow of fluid;
promotion of build-up of more fouling material;
increased hydraulic head loss of the flow fluid passes through the fluid treatment zone;
increased pressure/stress on a radiation source assembly; and
potential damage to equipment.

To the knowledge of the present inventors, the above mentioned fluid treatment systems do not teach a cleaning system capable of adequately and reliably removing such fouling material (e.g., elongate debris as discussed above) from the exterior surface of the radiation sources and/or other submerged surfaces in the fluid treatment system during operation of the system (i.e., without the need to cease operation of the system to remove the fouling material).

Accordingly, it would be desirable to have a fluid treatment system capable of removing such fouling material during operation of the system.

### SUMMARY OF THE INVENTION

It is an object of the present invention to obviate or mitigate at least one of the above-mentioned disadvantages of the prior art.

It is another object of the present invention to provide a novel cleaning apparatus for a radiation source assembly in a fluid treatment system.

It is another object of the present invention to provide a novel fluid treatment system.

Accordingly, in one of its aspects, the present invention provides cleaning apparatus for a radiation source assembly in a fluid treatment system, the cleaning apparatus comprising:

at least one cutting element; and

a motive element configured to cause relative movement between elongate debris in contact with the surface and the at least one cutting element to cause the at least one cutting element to cut the elongate debris.

The invention also relates to a radiation source module and to a fluid treatment system incorporating this cleaning apparatus.

In yet another of its aspects, the present invention relates to a method for removing elongate debris from an exterior surface of at least one radiation source assembly in a fluid treatment system as defined in the immediately preceding paragraph comprising the steps of:

(i) translating the wiping element from the first position toward the second position; and

(ii) causing the at least one cutting element to cut the elongate debris.

In a first embodiment, Steps (i) and (ii) are conducted concurrently. In a second embodiment Steps (i) and (ii) are conducted sequentially.

Preferably, the method comprises the further step of: (iii) translating the wiping element from the second position to the first position.

Thus, the present inventors have discovered a novel cleaning apparatus for use in a fluid treatment system for removing elongate debris from a surface of the fluid treatment system. The “surface of the fluid treatment system” may be any surface on or near which elongate debris is likely to reside. Thus, the “surface” may be comprised in portion of the fluid treatment system such as a sensor, a support element, a drive element, a radiation source assembly and the like. In a preferred embodiment, present cleaning apparatus comprises one or more annular wiping elements making it particularly suitable for use with cylindrical (e.g., rounded) elements and the like.

A preferred embodiment of the present cleaning apparatus further comprises one or both of a wiping element and a cutting surface element. In this preferred embodiment, the at least one cutting element and the cutting surface element are in spaced relation with respect to one another. In one particularly preferred embodiment of the invention, the at least one cutting element is coupled to the wiping element and the cutting surface element is relatively fixed. Alternatively, the cutting surface element may be coupled to the wiping element and the at least one cutting element may be relatively fixed.

Thus, the present cleaning apparatus is particularly advantageous for removing elongate debris from one or more radiation source assemblies disposed in the fluid treatment system. The preferred approach utilized in the present cleaning apparatus is to include at least one cutting element which is moved along the exterior of the radiation source assembly. The cutting element is connected to a wiping element that is translated between a first (e.g., retracted) position and a second (e.g., extended) position. As the wiping element is moved from the first position to the second position, it will tend to push the elongate debris toward a distal portion of the radiation source assembly. During this translation step, it is possible that some of the debris may be cut by the cutting element. As the wiping element approaches to distal portion of the radiation source assembly, it will tend to clamp down on the elongate debris and, as the force of movement is continually applied, the cutting element will cut the elongate debris. Once the elongate debris is cut, it will more readily fall away from the radiation source assembly and this action is facilitated by a flow of fluid past the radiation source assembly.

As mentioned above, in an alternate embodiment, the cutting element may be fixed and the cutting surface element may be coupled to the wiping element that is translated between a first position and a second position. As the wiping element is moved from the first position to the second position, it will tend to push the elongate debris toward a distal portion of the radiation source assembly. As the wiping element approaches the distal portion of the radiation source assembly, the cutting surface element (which may be integral with a portion of the wiping element) will tend to clamp down on the elongate debris and, as the force of movement is continually applied, the (relatively fixed) cutting element will cut the elongate debris. Once the elongate debris is cut, it will more readily fall away from the radiation source assembly and this action is facilitated by a flow of fluid past the radiation source assembly

Thus, the present cleaning apparatus allows for removing problematic debris such as elongate debris during regular operation of the fluid treatment system and without the need to shut down the system for servicing to remove the elongate debris. The present cleaning apparatus may or may not be incorporated in a radiation source module that contains one or more radiation source assemblies. In other words, it is possible to directly implement the present cleaning apparatus in a fluid treatment system.

The present cleaning apparatus is particularly well suited for implementation in a fluid treatment system wherein the radiation source assemblies are disposed transverse to the direction of fluid flow through the fluid treatment system.

### BRIEF DESCRIPTION OF THE DRAWINGS

Embodiments of the present invention will be described with reference to the accompanying drawings, wherein like reference numerals denote like parts, and in which:

FIG. 1 illustrates a perspective view, in partial cross section, of the present fluid treatment system;

FIG. 2 illustrates a side view of the fluid treatment system illustrated in FIG. 1 prior to removal of elongate debris from the radiation source assemblies (i.e., the cleaning apparatus is in the first position);

FIGS. 3-4 illustrate, in a sequential manner, movement of the cleaning apparatus from the first position to the second position;

FIGS. 5-10 illustrate, in a sequential manner, the action of the cutting element of the present cleaning apparatus as it approaches, reaches and is moved away from the second position;

FIG. 11 illustrates a schematic view of orientation of the cutting element of the present cleaning apparatus with respect to the direction of fluid flow through the fluid treatment system in which the cleaning apparatus is used;

FIG. 12 illustrates a perspective view, and partial cross section of the fluid treatment system illustrated in FIG. 1, after removal of the elongate debris from the exterior of the radiation source assembly;

FIG. 13 illustrates a perspective view of a preferred embodiment of the present radiation source module;

FIG. 14 illustrates the first alternate embodiment of a portion of the present cleaning apparatus;

FIG. 15 illustrates a schematic view of orientation of the cutting element of the cleaning apparatus illustrated in FIG. 14 with respect to the direction of fluid flow through the fluid treatment system in which the cleaning apparatus is used;

FIG. 16 illustrates the second alternate embodiment of a portion of the present cleaning apparatus;

FIG. 17 illustrates a schematic view of orientation of the cutting element of the cleaning apparatus illustrated in FIG. 16 with respect to the direction of fluid flow through the fluid treatment system in which the cleaning apparatus is used;

FIG. 18 illustrates an enlarged perspective view of a third alternate embodiment of the present cleaning apparatus; and

FIG. 19 illustrates an enlarged perspective view of a fourth alternate embodiment of the present cleaning apparatus.

### DETAILED DESCRIPTION OF THE PREFERRED EMBODIMENTS

In one of its aspects, the present invention relates to a cleaning apparatus. Preferred embodiments of the cleaning apparatus may include any one or a combination of any two or more of any of the following features:
the cleaning apparatus further comprises a debris translation element coupled to the motive element and wherein the motive element is configured to move the debris translation element between a first position and a second position;
the debris translation element is configured to be in contact with at least a portion of the surface;
the at least one cutting element is coupled to the debris translation element;
the debris translation element comprises a wiping element;
the cleaning apparatus further comprises a cutting surface element in spaced relation with respect to at least one cutting element, wherein movement of the debris translation element to the second position causes the at least one cutting element to approach the cutting surface element to cut elongate debris in contact with the surface;
the cutting surface element is fixed with respect to the at least one cutting element;
the cutting surface element is coupled to the debris translation element;
the cutting surface element is integrally formed in the debris translation element;
a plurality of cutting elements is connected to the debris translation element;
a pair of cutting elements is connected to the debris translation element, the pair of cutting elements being disposed in spaced relation to one another;
the cutting elements are oriented substantially parallel to one another;
the at least one cutting element comprises an elongate cutting edge;
the elongate cutting element is configured to be oriented at an angle with respect to the direction of fluid flow through the fluid treatment system;
the angle is from about 15° to about 75°;
the angle is from about 30° to about 60′;
the angle is from about 40° to about 50′;
the angle is about 45°;
the elongate cutting element is configured to be oriented substantially parallel to the direction of fluid flow through the fluid treatment system;
the elongate cutting element is configured to be oriented adjacent to an upstream portion of the surface;
the wiping element is annular;
the cleaning apparatus comprises a plurality of wiping elements;
the plurality of wiping elements is arranged in parallel with respect to one another;
the plurality of wiping elements is disposed in a carriage element coupled to the motive element;
each wiping element further comprises a suspension element operable to cushion the wiping element as it is moved to the first position or the second position;
each wiping element further comprises a suspension element operable to cushion the wiping element as it is moved to the first position and the second position;
the suspension element comprises a first biasing element connected to a distal portion of the wiping element and the carriage element, the first biasing element operable to compress when the wiping element is moved toward the second position and expand when the wiping element is moved toward the first position;
the suspension element comprises a second biasing element connected to a proximal portion of the wiping element and the carriage element, the second biasing element operable to compress when the wiping element is moved toward the first position and expand when the wiping element is moved toward the second position;
the carriage comprises a first plurality of wiping elements and a second plurality of wiping elements which are opposed with respect to the motive element;
the first plurality of wiping elements and the second plurality of elements contain the same number of wiping elements;
the wiping element comprises a cleaning element configured to remove at least a portion of undesired materials from the portion of the surface;
the cutting support element is comprised in a support plate element configured to be coupled to a distal portion of the exterior of the radiation source assembly, whereby in the second position of the wiping element, the least one cutting element and the support plate element combine to clamp elongate debris therebetween;
the wiping element comprises a seal for sealing engagement with the portion of the surface, the seal for removing at least a portion of undesired materials from the surface when the wiping element is moved from the first position to the second position;
the wiping element comprises a chamber for surrounding a portion of the surface;
the wiping element further comprises an inlet for introduction of a cleaning solution to the chamber;
the wiper element is configured for contact with at least a portion of an exterior an elongate substantially cylindrical element;
the wiper element is configured for contact with at least a portion of an exterior an elongate element having a rounded surface;
the wiper element is configured for contact with at least a portion of an exterior of the motive element;
the wiper element is configured for contact with at least a portion of an exterior of a radiation source assembly disposed in the fluid treatment system;
the cleaning apparatus further comprises a support plate element configured to be coupled to a distal portion of the exterior of the radiation source assembly, whereby in the second position of the wiping element, the least one cutting element and the support plate element combine to clamp elongate debris therebetween;
the support plate element comprises a recess for receiving at least a portion of the cutting element;
the support plate element is constructed from a resilient material; and/or
the support plate element is constructed from a non-metallic material.

The cleaning apparatus may be incorporated in a radiation source module that may include any one, or a combination of any two or more, of the following features:
the radiation source module further comprises means to position the radiation source module in the fluid treatment system;
the at least one radiation source assembly is in sealing engagement with the first support member;
the frame further comprises a second support member opposed to and laterally spaced from the first support member, at least a portion of the at least one radiation source assembly disposed between each of the first support member and the second support member;
the frame further comprises a third support member interconnecting the first support member and the second support member;
the frame further comprises a power supply for controlling the radiation source;
the radiation source assembly comprises a protective sleeve surrounding the radiation source;
the protective sleeve comprises a quartz sleeve;
the protective sleeve has an open end in sealed engagement with an opening in the first support member and a closed end supported by the second support member; and/or
the open end is sealed to prevent fluid ingress into the module.

The radiation source module may be incorporated in a fluid treatment system that may include any one or a combination of any two or more of any of the following features:
the fluid treatment zone is comprised in an open channel for receiving the flow of fluid;
the fluid treatment zone is comprised in a closed channel for receiving the flow of fluid;
the at least one radiation source assembly is elongate and has a longitudinal axis disposed transverse to the direction of fluid flow through the fluid treatment zone;
the at least one radiation source assembly is elongate and has a longitudinal axis disposed substantially parallel to the direction of fluid flow through the fluid treatment zone;
the at least one radiation source assembly is elongate and has a longitudinal axis disposed orthogonal to the direction of fluid flow through the fluid treatment zone; and/or
the at least one radiation source assembly is elongate and is disposed substantially vertically in the fluid treatment zone.

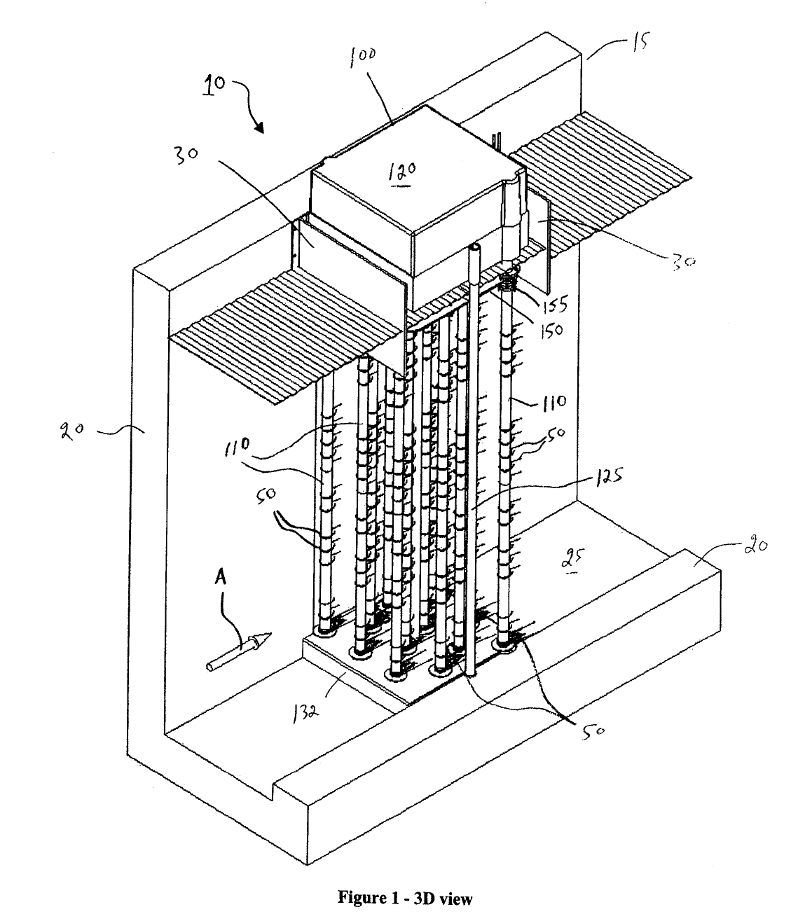

With reference to FIGS. 1-4, there is illustrated a fluid treatment system 10. Fluid treatment system 10 comprises an open channel 15 having a pair of sidewalls 20 (only a portion of one of sidewalls 20 is shown in FIG. 1 for clarity) and a floor 25. Attached to sidewalls 20 of open channel 15 are a pair of baffle plates 30 which span a distance between sidewalls 20 of open channel 15. The use and function of such baffle plates is described in more detail, in, for example, International Publication No. WO 2008/019490 [Traubenberg et al.].

Disposed between baffle plates 30 is a radiation source module 100. Radiation source module 100 comprises a series of radiation source assemblies 110. The distal portions of radiation source assemblies are coupled to a footer 132 that spans a distance between pair of sidewalls 20 of open channel 15. Footer 132 includes a series of apertures for receiving the distal ends of radiation source assemblies 110. The proximal portions of radiation source assemblies 110 are connected to and supported by a module header 120. Additional details on the construction and components in module header 120 may be found in co-pending U.S. provisional patent application Ser. No. 61/202,797 [Traubenberg et al.], filed on Apr. 24, 2009.

Each radiation source assembly 110 may comprise a radiation source (not shown for clarity) disposed in a radiation transparent protective sleeve as described above. Preferably, the radiation source is an ultraviolet (UV) radiation source.

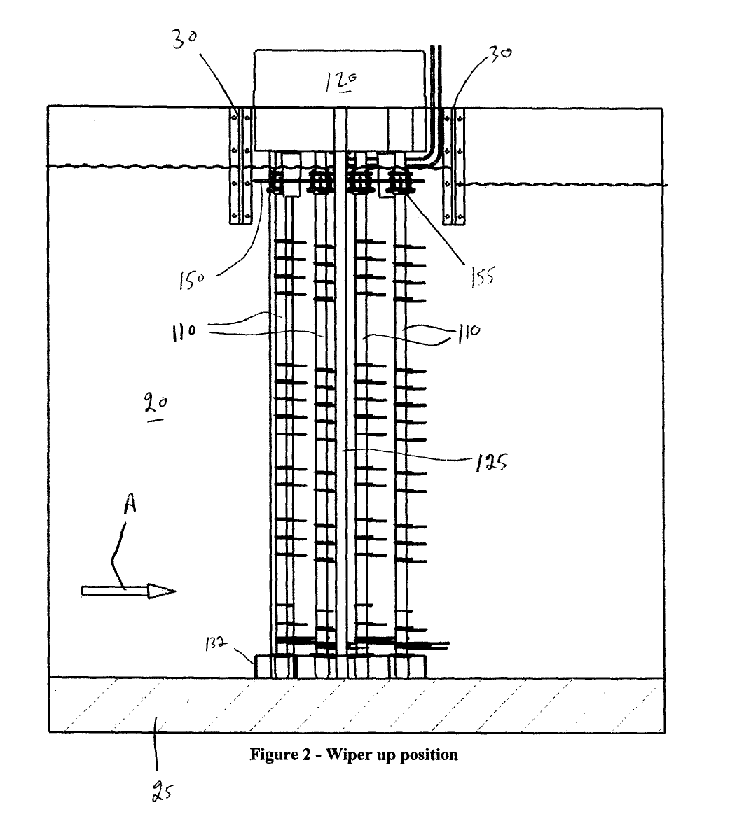

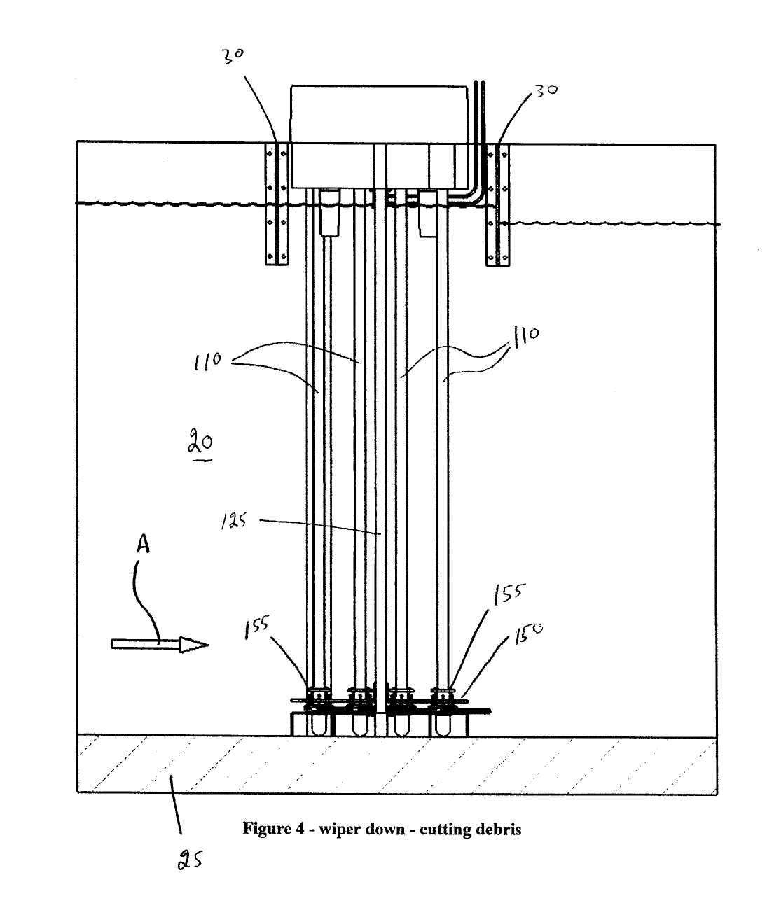

A cleaning apparatus 150 comprises a series of wiping elements 155 engaged to the exterior of each radiation source assembly 110—preferably each wiping element 155 also functions as a cleaning element. Cleaning apparatus 150 is connected to a drive element (not shown) which is configured to move cleaning apparatus 150 from a first position (FIG. 2) to a second position (FIG. 4). While the precise nature of the drive element is not particularly restricted, it is preferred that the drive element is of the type illustrated in U.S. Pat. No. 6,342,118 [Pearcey et al.] or of the type illustrated in co-pending U.S. provisional patent application Ser. No. 61/202,576 [Penhale et al.], filed Mar. 13, 2009. Details of connections and operation of the drive element may also be found in Pearcey et al. and Penhale et al.

A pair of support elements 125 (only one is shown for clarity) serve to interconnect modular header 120 with footer 132. This allows for radiation source module 100 to be considered as a unit or repeating element that may be placed in open channel 15 such that the bottom of footer 132 of radiation source module 100 rests on floor 25 of open channel 15.

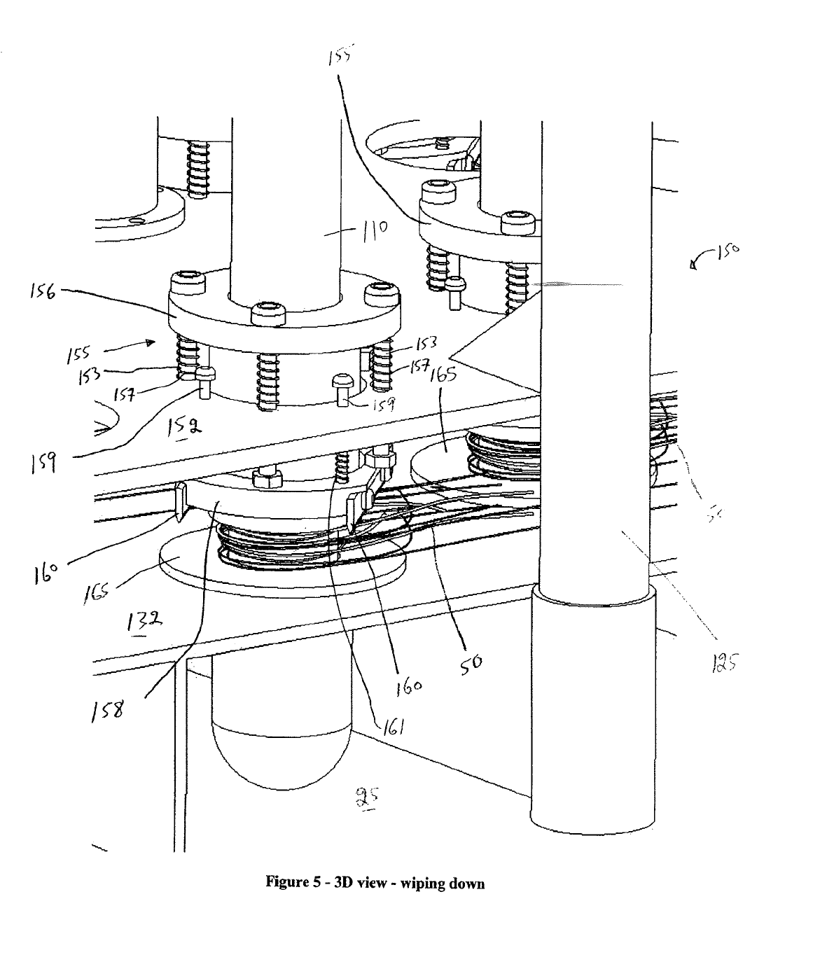

With particular reference to FIG. 5, cleaning apparatus 150 comprises a series of cleaning elements 155. Each wiping element 155 is annular and surrounds a radiation source assembly 110. A proximal portion 156 of wiping element 155 is coupled to a carriage 152 via bolt 153. A spring 157 surrounds bolt 153 and serves to create a suspension function between proximal portion 156 of wiping element 155 and carriage 152. A similar function is created between a distal portion 158 of wiping element 155 via a bolt 159 which is surrounded by a spring 161. Thus, the combination of bolt 159 and spring 161 creates a suspension function between distal portion 158 of wiping element 155 and carriage 152.

As can be seen, each distal portion 158 of wiping element 155 comprises a pair of cutting elements 160. Cutting elements 160 are elongate and oriented to be at an angle to the direction of fluid flow past radiation source assemblies 110—this will be discussed further below.

As shown in FIGS. 1-4, a flow of fluid passes by radiation source assemblies 110 in the direction of Arrow A. During normal use of fluid treatment system 10, string-like or elongate debris 50 will catch or otherwise snag on the exterior of radiation source assemblies 110.

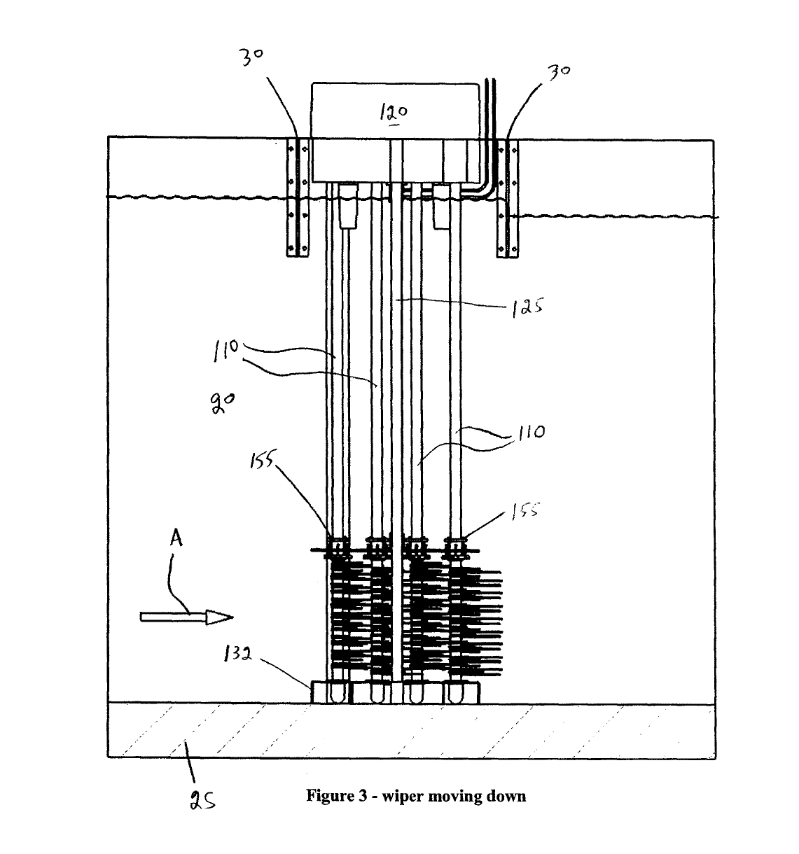

When is it desired to remove elongate debris 50 from the exterior surfaces of radiation source assemblies 110, the drive element to which cleaning apparatus 150 is connected is actuated to translate cleaning apparatus 150 toward the distal ends of radiation source assemblies 110—see particularly FIGS. 3 and 4. This has the effect of moving (e.g., pushing) elongate debris 50 toward footer 132 as shown sequentially in FIGS. 2-4.

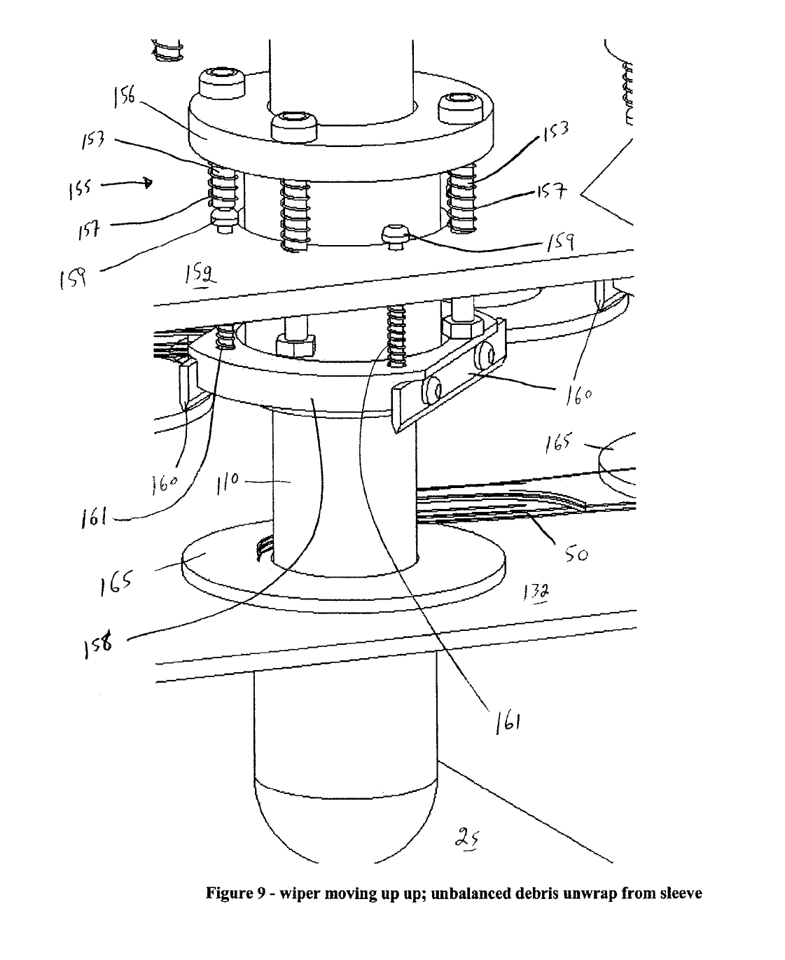

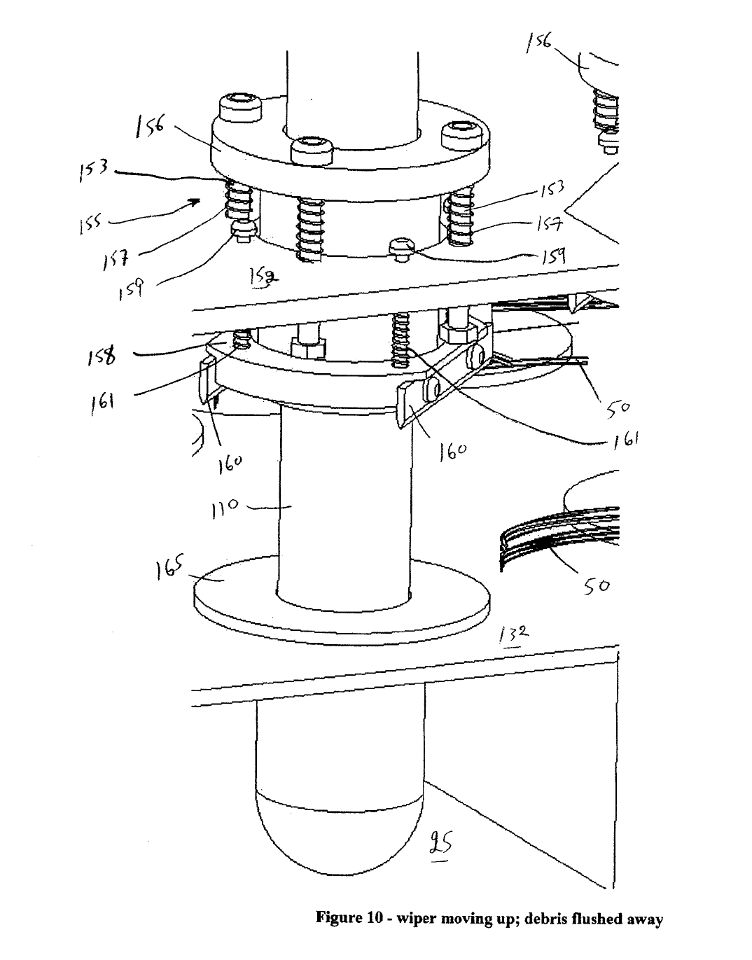

FIGS. 5-10 illustrate, in a sequential manner, the operation of cleaning apparatus 150 as it approaches the distal ends of radiation source assemblies 110. As shown, a support element 165 is positioned to sit on footer 132. Preferably, support element 165 is made from a resilient material or a non-metallic material. Support element 165 functions much like a “chopping block” for the cutting of elongate debris 50 as will be described below.

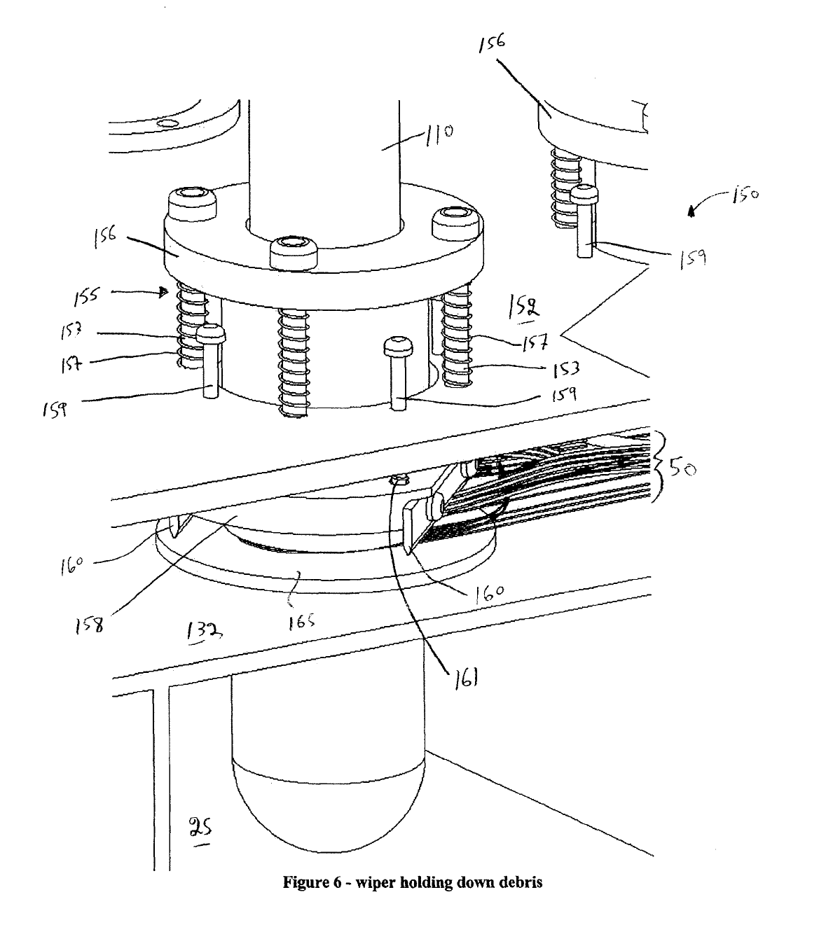

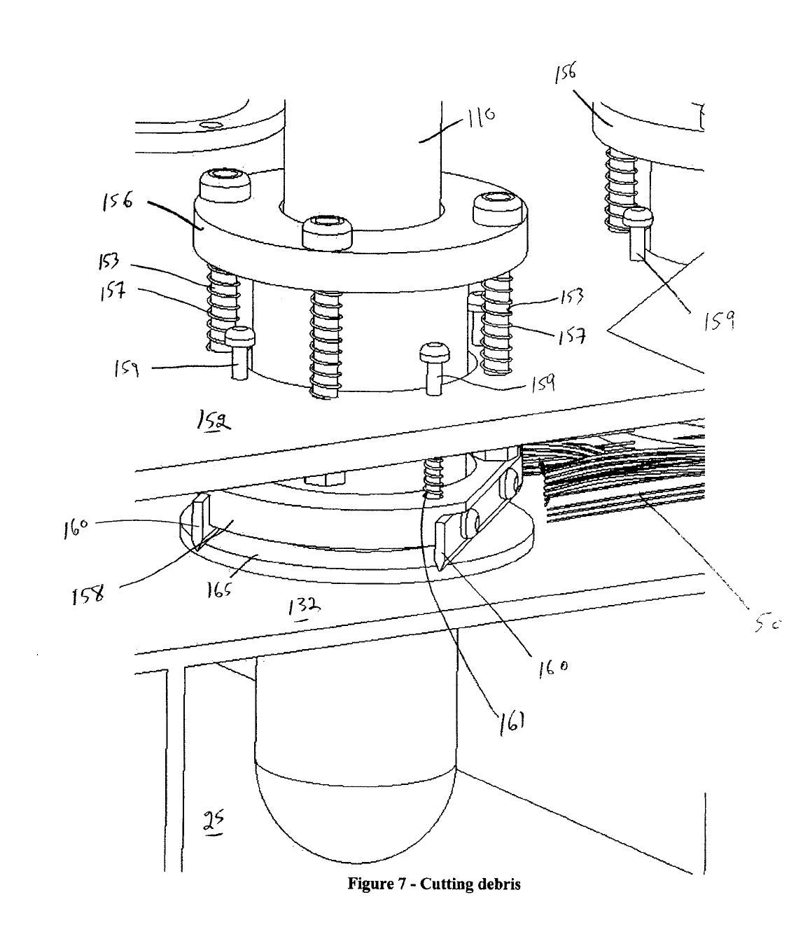

With reference to FIG. 5, as cleaning apparatus approaches footer 132, elongate debris 50 tends to bunch between the distal surface of wiping element 155 and support element 165. With reference to FIG. 6, continued downward movement of cleaning apparatus 150 results in distal portion 158 of wiping element 155 clamping down on elongate debris 50. Continued downward movement of cleaning apparatus 150 results in cutting of the elongate debris 50 by cutting elements 160—see FIG. 7. With continued reference to FIG. 7, the portion of elongate debris 50 that is downstream of cutting element 160 is carried by the flow of fluid downstream of radiation source assembly 110 and exits fluid treatment system 10 in the flow of fluid.

The above-mentioned suspension effect created between proximal portion 156 of wiping element 155 and carriage 152 obviates or mitigates a disproportionate force being applied by cleaning apparatus 150 to support elements 165. This accounts for the event where there are different amounts of elongate debris 50 attached different radiation source assemblies 110. This also compensates for slight misalignment of the various elements due to normal manufacturing tolerances. Thus, jamming of cleaning apparatus 150 and consequential risk of breaking radiation source assemblies 110 is minimized or avoided. This is particularly important when there is a single drive element being used to move a relatively large number of wiping elements 155, more particularly when those large number of wiping elements 155 are spaced apart over a relatively large area.

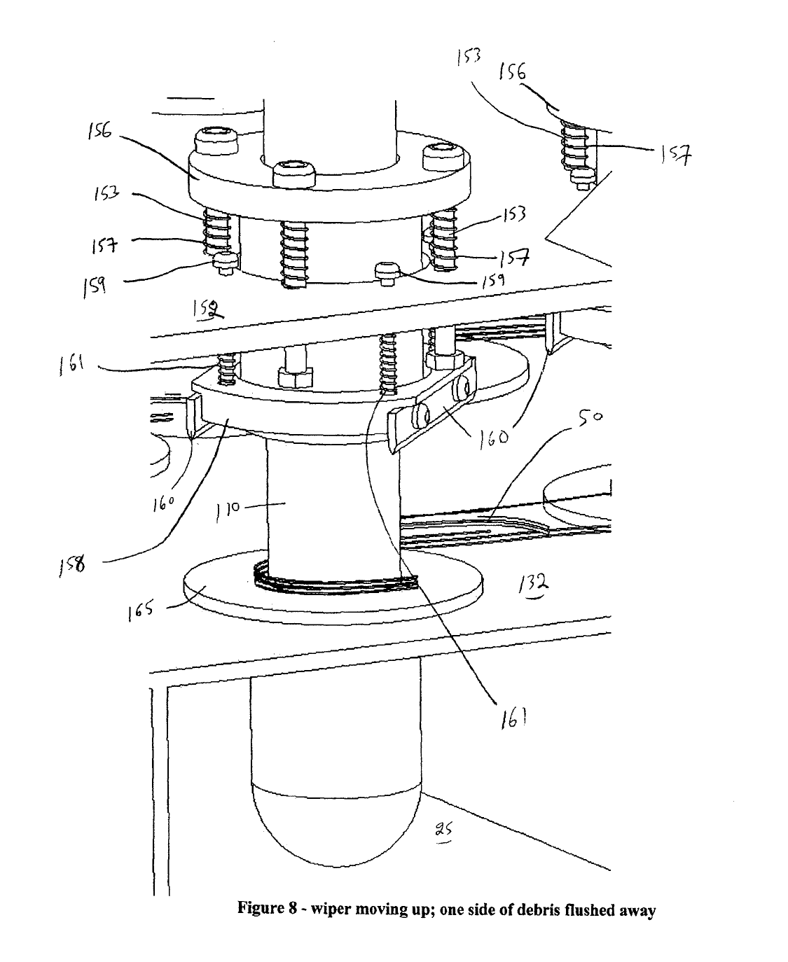

With reference to FIGS. 8-10, cleaning apparatus 150 is moved toward the first position. As this happens any remaining debris on the exterior of radiation source assembly 110 is carried away by the flow of fluid owing to the relative imbalance of the remaining debris resulting from the cutting step illustrated in FIG. 7.

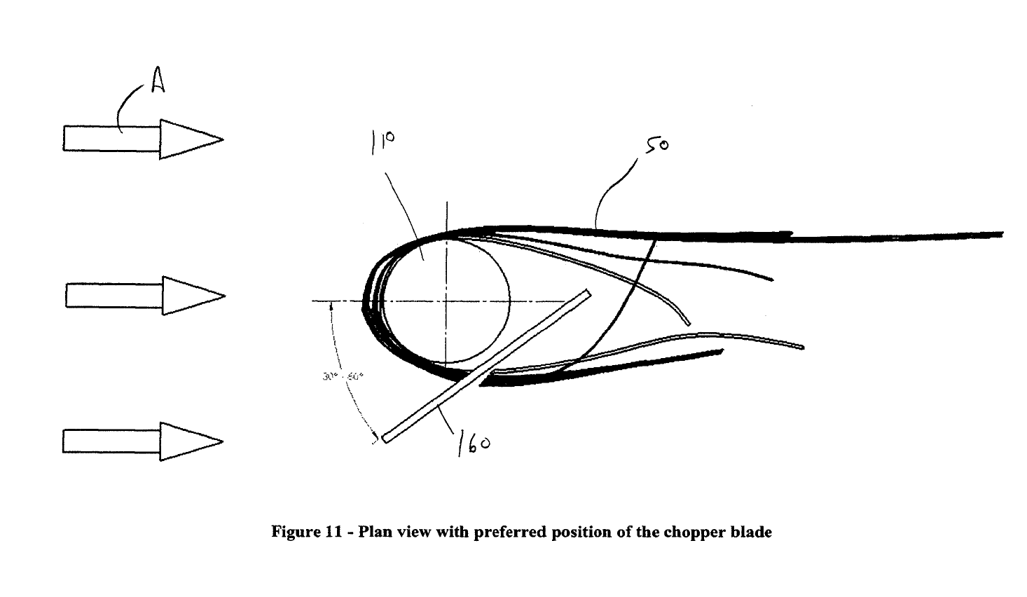

With reference to FIG. 11, there is a illustrated schematic top view of orientation of cutting element 160 with respect to the direction of fluid flow represented by arrow A. As shown, it is preferred that elongate cutting element 160 be disposed at an angle with respect to the direction of fluid flow past radiation source assembly 110. Preferably, the angle is from about 15° to about 75°, more preferably from about 30° to about 60°, even more preferably from about 40° to about 50°, most preferably, about 45°.

The positioning of cutting element 160 in this manner results in asymmetric cutting of elongate debris. By “asymmetic cutting” is meant that cutting action applied to a piece of elongate debris generally results in two pieces of different length and weight. This result, coupled with the fact that the cut takes place away from the most upstream point of the radiation source assembly, allows the fluid flowing past the radiation source assembly to facilitate release of the elongate debris from the radiation source assembly. A further advantage of positioning cutting element 160 in this manner is that it is also for a provision of a gap between cutting element 160 and radiation source assembly 110 to allow wiping element 155 to operate in the same vicinity (re. radiation source arc length and position) as cutting element 160.

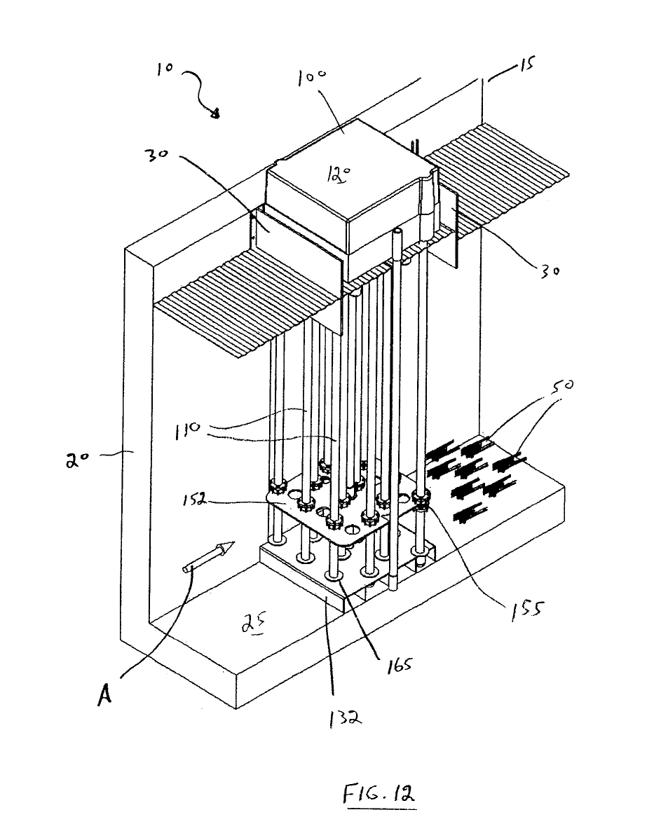

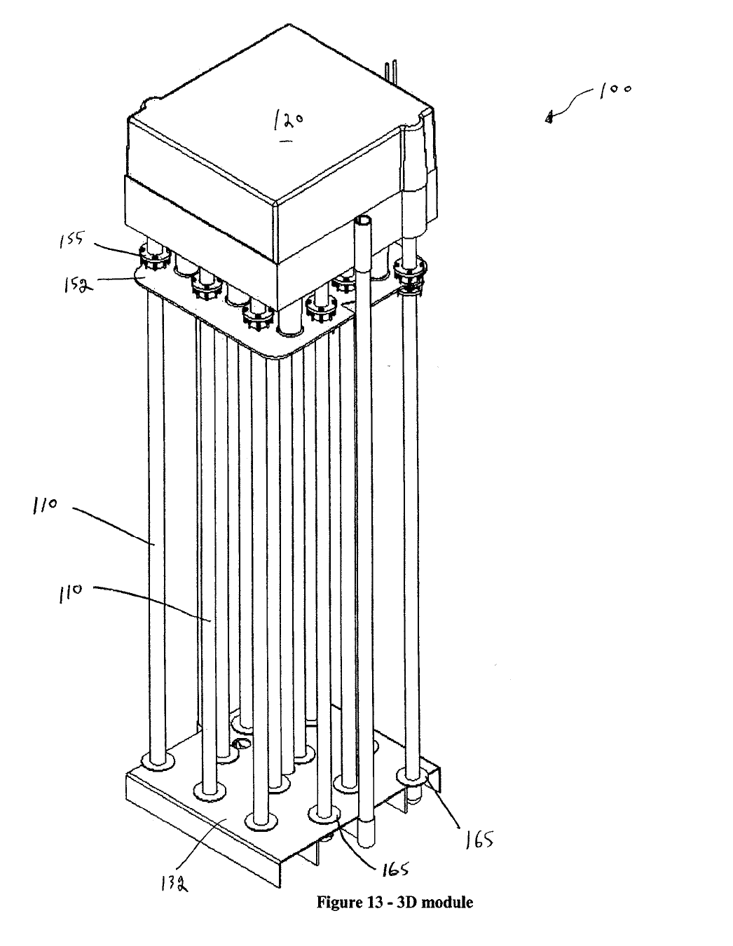

FIG. 13 illustrates an enlarged perspective view of a preferred embodiment of radiation source module 100 illustrated in FIGS. 1-12.

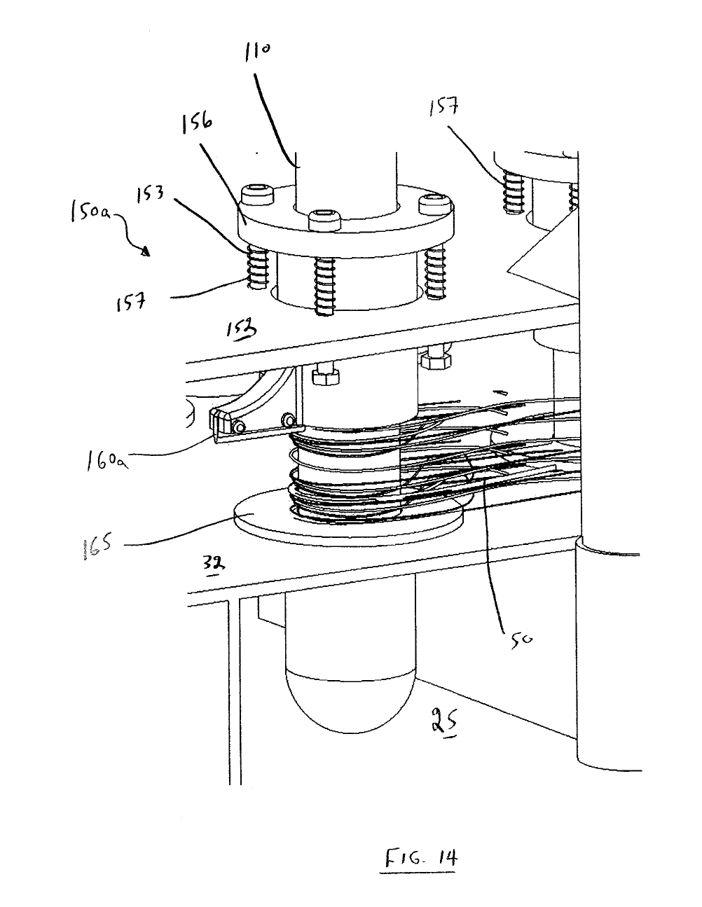

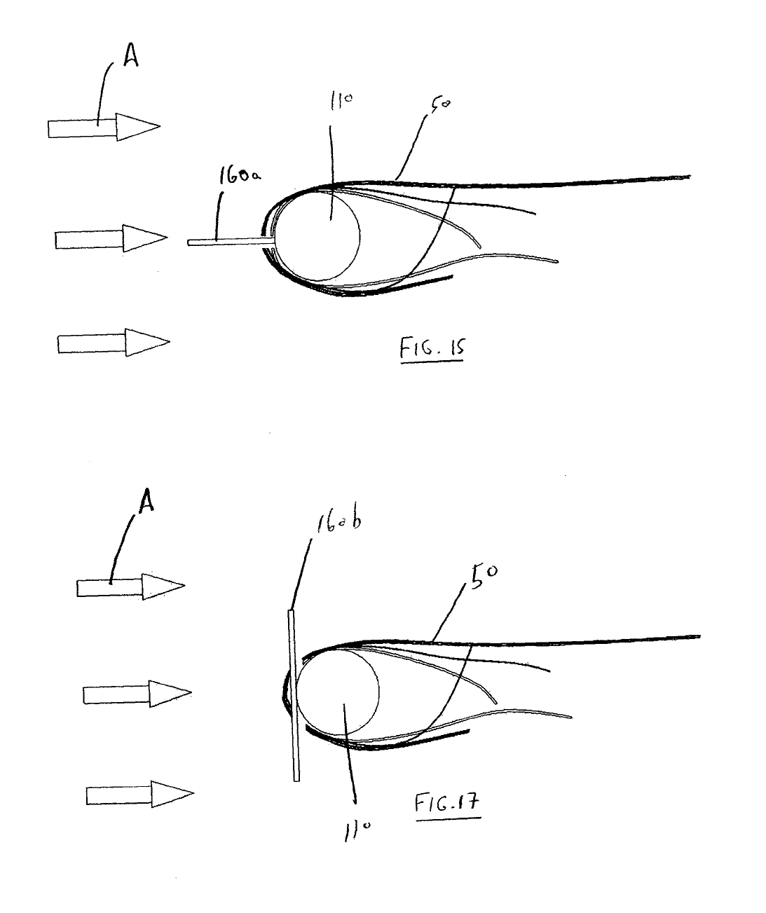

With reference to FIGS. 14 and 15, there is illustrated a first alternate embodiment of cleaning apparatus 150a. In this alternate embodiment, the following modifications have been made to cleaning apparatus 150 described above with reference to FIGS. 5-10;
flanged distal portion 158 of wiping element 155 has been omitted, together with bolt 159 and spring 161;
pair of cutting elements 160 have been replaced by a single cutting element 160a disposed such that the elongate cutting edge of cutting element 160a is disposed substantially parallel to the direction of fluid flow past radiation source assembly 110—see FIG. 15.
   In this embodiment, cutting element 160a is placed very close to the surface of radiation source assembly 110. An advantage of this approach is that cutting element 160a need not necessarily be implemented with a wiping element that also functions as a cleaning element—e.g., the chemical/mechanical cleaning element described in the Maarschalkerweerd #2 patents described above.

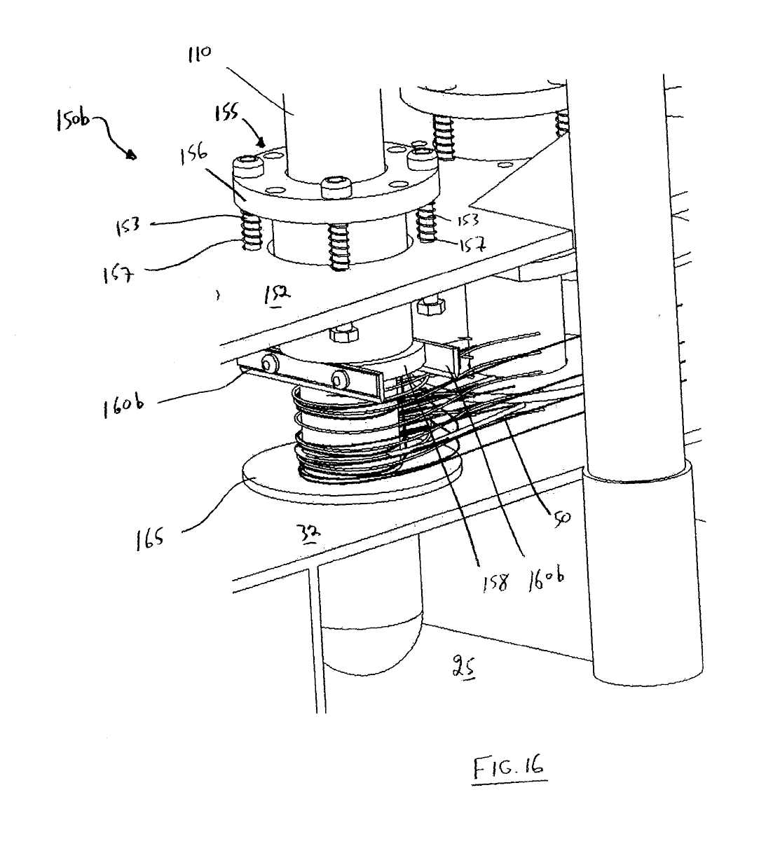

With reference to FIGS. 16 and 17, there is illustrated an alternate embodiment of cleaning apparatus 150b in which bolt 159 and springs 161 have been omitted and cutting elements 160b have been oriented such that elongate cutting edge thereof is disposed substantially orthogonal with respect to a direction of fluid flow past radiation source assembly 110—see FIG. 17 (only one of cutting elements 160b is shown for clarity). An advantage of this arrangement is each cutting element 160b is oriented such that it can effect two cuts on a single piece of elongate debris 50 thereby facilitating flushing away of elongate debris 50 after it has been cut.

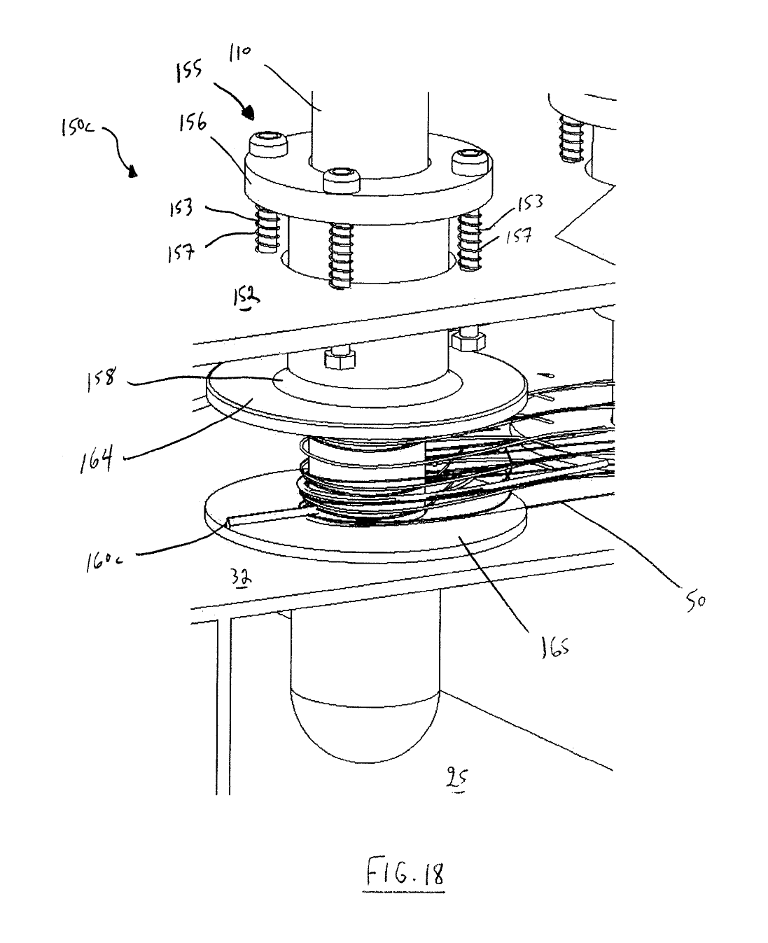

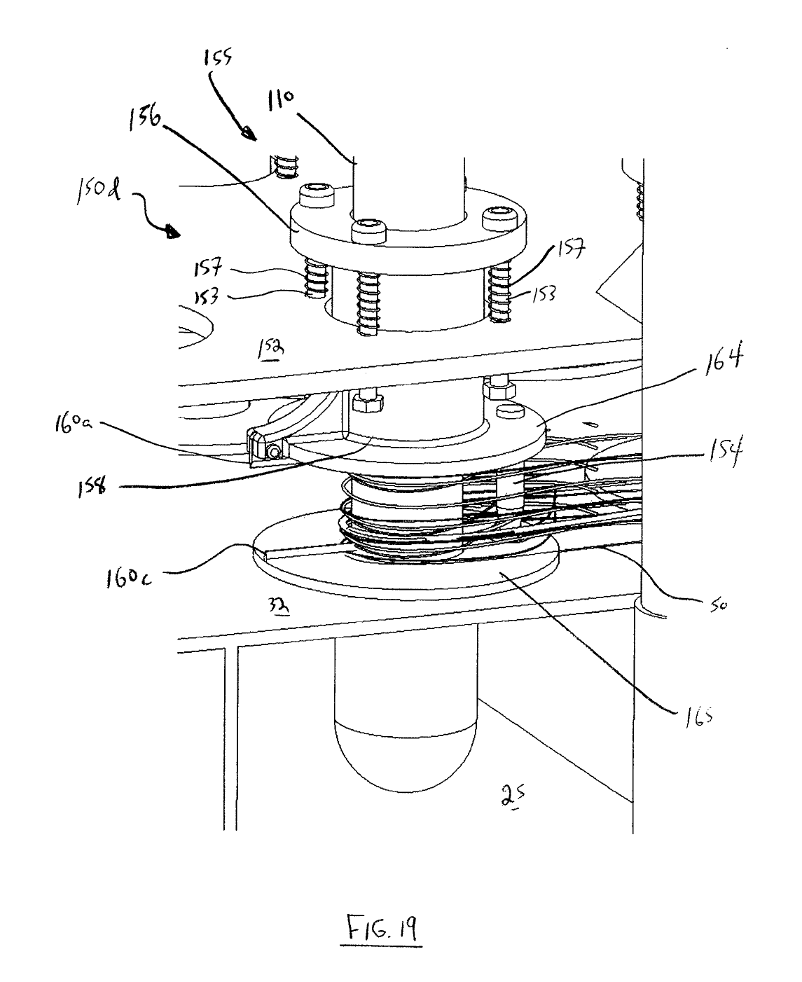

With reference to FIG. 18, there is shown an cleaning apparatus 150c. Cleaning apparatus 150c differs for the cleaning apparti shown in FIGS. 1-17 inasmuch as, in cleaning apparatus 150c, a cutting element 160c is fixed to support element 165 and a cutting surface element 164 is coupled to distal portion 158 of wiping element 155. As will be appreciated by those of skill in the art, as wiping element 155 is moved to the second position, cutting surface element 164 will push elongate debris 50 toward support element 165. With continued movement of wiping element 155 toward the extended position, cutting surface element 164 will tend to clamp elongate debris 50 against support element 155 and cutting element 160c will tend to cut elongate debris 50. The cut debris will be flushed away from radiation source assembly 110 in a manner similar to that described above.

With reference to FIG. 19, there is shown a cleaning apparatus 150d. Cleaning apparatus 150d is effectively a combination of the embodiments illustrated in FIGS. 14 and 18 wherein cutting elements 160a and 160c are configured in a manner to provide a cutting action that shears elongate debris 50—i.e., the cutting edges of cutting elements 160a and 160c shear past one another. Connected to cutting surface element 164 is a guidepin 154 that facilitates creation of the shearing action between cutting elements 160a and 160c. Again, the cut debris will be flushed away from radiation source assembly 110 in a manner similar to that described above.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

1. A cleaning apparatus for a surface in a fluid treatment system, the cleaning apparatus comprising:
at least one cutting element; and
a motive element configured to cause relative movement between elongate debris in contact with the surface and the at least one cutting element to cause the at least one cutting element to cut the elongate debris.

2. The cleaning apparatus defined in claim 1, further comprising a debris translation element coupled to the motive element and wherein the motive element is configured to move the debris translation element between a first position and a second position.

3. The cleaning apparatus defined in claim 2, wherein the debris translation element is configured to be in contact with at least a portion of the surface.

4. The cleaning apparatus defined in claim 3, wherein the at least one cutting element is coupled to the debris translation element.

5. The cleaning apparatus defined in claim 4, wherein the debris translation element comprises a wiping element.

6. The cleaning apparatus defined in claim 5, further comprising a cutting surface element in spaced relation with respect to at least one cutting element, wherein movement of the debris translation element to the second position causes the at least one cutting element to approach the cutting surface element to cut elongate debris in contact with the surface.

7. The cleaning apparatus defined in claim 6, wherein the cutting surface element is fixed with respect to the at least one cutting element.

8. The cleaning apparatus defined in claim 7, wherein the debris translation element is coupled to the wiping element.

9. The cleaning apparatus defined in claim 8, wherein the cutting surface element is integrally formed in the debris translation element.

10. The cleaning apparatus defined in claim 9, wherein a plurality of cutting elements is connected to the debris translation element.

11. The cleaning apparatus defined in claim 9, wherein a pair of cutting elements is connected to the debris translation element, the pair of cutting elements being disposed in spaced relation to one another.

12. The cleaning apparatus defined in claim 11, wherein the cutting elements are oriented substantially parallel to one another.

13. The cleaning apparatus defined in any one of claim 12, wherein the at least one cutting element comprises an elongate cutting edge.

14. The cleaning apparatus defined in any one of claim 13, wherein the elongate cutting element is configured to be oriented at an angle with respect to the direction of fluid flow through the fluid treatment system.

15. The cleaning apparatus defined in claim 14, wherein the angle is from about 15° to about 75°.

16. (canceled)

17. (canceled)

18. (canceled)

19. The cleaning apparatus defined in any one of claim 14, wherein the elongate cutting element is configured to be oriented substantially parallel to the direction of fluid flow through the fluid treatment system.

20. The cleaning apparatus defined in claim 19, wherein the elongate cutting element is configured to be oriented adjacent to an upstream portion of the surface.

21. The cleaning apparatus defined in any one of claim 20, wherein the wiping element is annular.

22. The cleaning apparatus defined in any one of claim 21, comprising a plurality of wiping elements.

23. The cleaning apparatus defined in claim 22, wherein the plurality of wiping elements is arranged in parallel with respect to one another.

24. The cleaning apparatus defined in any one of claim 23, wherein the plurality of wiping elements is disposed in a carriage element coupled to the motive element.

25. The cleaning apparatus defined in claim 24, wherein each wiping element further comprises a suspension element operable to cushion the wiping element as it is moved to the first position or the second position.

26. The cleaning apparatus defined in claim 24, wherein each wiping element further comprises a suspension element operable to cushion the wiping element as it is moved to the first position and the second position.

27. The cleaning apparatus defined in claim 26, wherein the suspension element comprises a first biasing element connected to a distal portion of the wiping element and the carriage element, the first biasing element operable to compress when the wiping element is moved toward the second position and expand when the wiping element is moved toward the first position.

28. The cleaning apparatus defined in claim 27, wherein the suspension element comprises a second biasing element connected to a proximal portion of the wiping element and the carriage element, the second biasing element operable to compress when the wiping element is moved toward the first position and expand when the wiping element is moved toward the second position.

29. The cleaning apparatus defined in claim 28, wherein the carriage element comprises a first plurality of wiping elements and a second plurality of wiping elements which are opposed with respect to the motive element.

30. The cleaning apparatus defined in claim 29, wherein the first plurality of wiping elements and the second plurality of elements contain the same number of wiping elements.

31-38. (canceled)

39. The cleaning apparatus defined in claim 30, wherein the wiper element is configured for contact with at least a portion of an exterior of a radiation source assembly disposed in the fluid treatment system.

40. The cleaning apparatus defined in claim 39, wherein the cutting support element is comprised in a support plate element configured to be coupled to a distal portion of the exterior of the radiation source assembly, whereby in the second position of the wiping element, the least one cutting element and the support plate element combine to clamp elongate debris therebetween.

41. The cleaning apparatus defined in claim 40, wherein the support plate element comprises a recess for receiving at least a portion of the cutting element.

42. The cleaning apparatus defined in any one of claim 41, wherein the support plate element is constructed from a resilient material.

43. The cleaning apparatus defined in any one of claim 41, wherein the support plate element is constructed from a non-metallic material.

44-67. (canceled)
